(19) United States
(12) Patent Application Publication
(10) Pub. No.: US 2016/0064762 A1
(43) Pub. Date: Mar. 3, 2016

(54) MEMBRANE ELECTRODE ASSEMBLY COMPRISING A GAS DIFFUSION LAYER IN PRESSED SEALING ELEMENT, AND PRODUCTION APPARATUS FOR AND METHOD OF MANUFACTURING A MEMBRANE ELECTRODE ASSEMBLY

(71) Applicant: Volkswagen Aktiengesellschaft, Wolfsburg (DE)

(72) Inventors: Julie BELLERIVE, Burnaby (CA); Tommy CHENG, Burnaby (CA)

(21) Appl. No.: 14/842,055

(22) Filed: Sep. 1, 2015

(30) Foreign Application Priority Data
Sep. 2, 2014 (DE) 102014217509.7

(51) Int. Cl. H01M 8/10; H01M 8/02; H01M 8/04

(52) U.S. Cl. CPC H01M 8/1004; H01M 8/04201; H01M 8/0271; H01M 8/0286

(57) ABSTRACT

The invention relates to a membrane electrode assembly for a fuel cell and a method for producing and a production device for producing such a membrane electrode assembly. In order to be able to provide a fuel cell which has the membrane electrode assembly so as to have a high energy density, there is provision according to the invention for the sealing element to be pressed into the gas diffusion layer.

### BACKGROUND OF THE INVENTION

The invention relates to a membrane electrode assembly for a fuel cell, having a membrane, having two electrodes between which the membrane is arranged, having two gas diffusion layers between which the membrane having the two electrodes is arranged, and having two sealing elements, one of which contacts one of the gas diffusion layers. The invention further relates to a method for producing a membrane electrode assembly for a fuel cell, in which a membrane is arranged between two electrodes, one gas diffusion layer is formed at a side of each of the electrodes facing away from the membrane, and one sealing element is brought into contact with one of the gas diffusion layers. Furthermore, the invention relates to a production device for producing a membrane electrode assembly having a gas diffusion layer.

Membrane electrode assemblies for fuel cells and production devices for producing and methods for producing membrane electrode assemblies for fuel cells are generally known.

Fuel cells use the chemical conversion of a fuel with oxygen in order to produce electrical energy. To this end, fuel cells contain as the core component membrane electrode assemblies which may be constructed in each case as a compound comprising an ion-conducting, in particular proton-conducting, membrane and in each case an electrode (anode and cathode) which is arranged at both sides on the membrane. In addition, gas diffusion layers may be arranged at both sides of the membrane electrode unit at the sides of the electrodes facing away from the membrane. Generally, the fuel cell has a large number of membrane electrode assemblies which are arranged in a stack and whose electrical powers are added together. During operation of the fuel cell, the fuel, in particular hydrogen (H₂) or a hydrogen-containing gas admixture, is supplied to the anode, where an electro-chemical oxidation of H₂ to H⁺ is carried out with release of electrons. By means of an electrolyte or the membrane which separates and electrically insulates the reaction spaces from each other in a gas-tight manner, there is brought about a water-based or water-free transport of the protons (H⁺) from the anode space into the cathode space. The electrons produced at the anode are supplied to the cathode by means of an electrical line. Oxygen (O₂) or an oxygen-containing gas admixture is supplied to the cathode so that a reduction from O₂ to O²⁻ is carried out with the electrons being taken up. At the same time, these oxygen anions react in the cathode space with the protons transported via the membrane, with water being formed. As a result of the direct conversion of chemical into electrical energy, fuel cells achieve an improved degree of efficiency compared with other electricity generators as a result of the avoidance of the Carnot factor.

The fuel cell is thus formed by means of a large number of individual cells which are arranged in a stack so that this is also referred to as a stack of fuel cells. Between the membrane electrode assemblies, there are arranged bipolar plates which ensure the individual cells are supplied with the operating media, that is to say, the reactands, and a tempering medium. In addition, the bipolar plates can ensure an electrically conductive contact with respect to the membrane electrode units.

In order to now prevent one of the operating media from being able to be discharged laterally from the membrane electrode assembly in an undesirable manner, there is provided the sealing element which extends around, for example, a face of the membrane electrode assembly which is involved in the reaction of the operating media. In this instance, however, it should be noted that for current fuel cell devices a large number of membrane electrode assemblies are stacked together. The thicker the membrane electrode assembly is, the lower the power density of such a fuel cell device. Consequently, it is desirable for the membrane electrode assembly to be constructed to be as thin as possible in order to be able to provide a fuel cell device with a high level of energy density.

In known fuel cell devices, an attempt is made to reduce an increase of the thickness of the membrane electrode assembly which is caused by the sealing element in that the sealing element is arranged in a recess which is provided in a bipolar plate which is in abutment with the membrane electrode assembly. However, the recess again results in a specific minimum thickness of the bipolar plate which limits the energy density.

### SUMMARY OF THE INVENTION

An object of the invention is to provide a membrane electrode assembly and a method for producing and a production device for producing a membrane electrode assembly, wherein a fuel cell device with a high energy density can be produced by using the membrane electrode assembly.

For the membrane electrode assembly mentioned in the introduction, the object is achieved in that at least one of the sealing elements is pressed into the gas diffusion layer. The object is achieved for the method mentioned in the introduction in that at least one of the sealing elements is pressed into the gas diffusion layer with which the sealing element has been brought into contact. For the production device mentioned in the introduction, the object is achieved with a pressing device, the pressing device being constructed to press a sealing element into the gas diffusion layer.

As a result of the fact that the sealing element is pressed into the gas diffusion layer, an overall thickness of the membrane electrode assembly is reduced so that a fuel cell device which has the membrane electrode assembly can be operated at a higher energy density. Furthermore, the porosity of the gas diffusion layer which is pressed together is lower than the porosity of a portion of the gas diffusion layer, which portion has not been pressed together by the sealing element, so that, in the region of the sealing element, the gas diffusion layer has a lower gas permeability and the sealing effect is increased.

The solution according to the invention can be further improved by means of different embodiments which are each advantageous per se and which can be readily combined with each other unless stated otherwise. These embodiments and the advantages connected therewith will be set out below.

It is thus possible for the gas diffusion layer, in which the sealing element is pressed, and the sealing element which is pressed into the gas diffusion layer to be in alignment with each other. If the sealing element and the gas diffusion layer are in alignment with each other so that the sealing element does not protrude from the gas diffusion layer or the gas diffusion layer protrudes away from the membrane, the minimum possible thickness of the membrane electrode assembly is achieved.

For example, the sealing element may be placed at a side of one of the gas diffusion layers facing away from the membrane and may then be pressed therein. Furthermore, the side of the gas diffusion layer in which the sealing element is pressed, which side faces away from the membrane, and the side of the sealing element facing away from the membrane may be in alignment with each other. If the two sides facing away from the membrane are in alignment with each other, the minimum possible thickness of the membrane electrode assembly is achieved.

During the method for producing the membrane electrode assembly, the sealing element may be pressed so far into the gas diffusion layer that the sealing element and, for example, the sides of the sealing element facing away from the membrane and the gas diffusion layer and in particular the side thereof facing away from the membrane are in alignment with each other.

In order to prevent the gas permeability from being impaired in a portion of the gas diffusion layer involved in the reaction of the operating media, a portion of the gas diffusion layer not pressed together by the sealing element is preferably not pressed together. This is because the portion involved in the reaction of the operating media is constructed so as to allow one of the operating media to pass perpendicularly relative to the membrane electrode assembly. If this portion has an adequate gas permeability, the maximum electrical power which can be produced by the fuel cell decreases.

Alternatively, a force which presses the sealing element into the gas diffusion layer can also act in a portion which is adjacent to the sealing element in order to ensure that the sealing element is completely acted on with the force.

As a result of the fact that only the sealing element, and not portions of the gas diffusion layer involved in the reaction of the operating media, is compressed, a gas diffusion rate or surface permeability of the non-compressed gas diffusion layer does not decrease. However, if the entire layer were compressed in order to reduce the thickness of the membrane electrode assembly, the quantity of operating medium which could flow through the membrane electrode assembly at a predetermined pressure would be reduced. For example, the quantity of operating medium which can flow during operation through the non-compressed portions of the gas diffusion layer is 1.54 ml per minute. The operating medium pressure may, for example, comprise 1.6 Megapascal during operation. If the entire gas diffusion layer were to be compressed, the permeability of the gas diffusion layer would decrease, whereby the efficiency of a fuel cell which has the membrane electrode assembly would decrease.

During the production method, a pressing force may thus be introduced during pressing only into the sealing element and preferably not into portions of the gas diffusion layer on which the sealing element is not supported.

In order to be able to apply a pressure only to the sealing element and not to portions of the gas diffusion layer which are adjacent to the sealing element and which are not intended to be compressed thereby, the pressing device may have a pressing tool whose active cross-section corresponds to the shape of the sealing element.

Alternatively, the active cross-section may be sized to be slightly larger than the sealing element in order to ensure that the sealing element is completely in abutment with the pressing tool, even when the sealing element and the pressing tool are not orientated correctly with respect to each other.

For example, the production device may have a second coating device for applying the sealing element, wherein the second coating device may have a mask which determines the shape of the sealing element and wherein the active cross-section of the pressing tool is formed so as to substantially complement the mask. For example, the active cross-section may correspond to a pressing face of the pressing tool, wherein the active cross-section corresponds to the shape of a side of the sealing element facing the pressing tool. An application of the pressing force directly to the gas diffusion layer thus does not take place. The pressing tool applies the pressing force only to the sealing element so that the gas diffusion layer is compressed only at locations at which the sealing element is pressed therein.

If it is not the thickness of the membrane electrode assembly, but instead the gas permeability or permeability of the gas diffusion layer which is intended to be improved, the membrane electrode assembly according to the invention with the same thickness as a known membrane electrode assembly may have an improved permeability since the gas diffusion layer may be constructed to be thicker in comparison with known membrane electrode assemblies. As a result of the sealing element which is pressed into the gas diffusion layer, the thickness of the membrane electrode assembly with a thicker gas diffusion layer is not greater than with known membrane electrode assemblies having a comparatively thinner gas diffusion layer.

When the sealing element is applied, a material which forms the sealing element may, for example, be fluid and be pressed onto the gas diffusion layer. The mask may be provided in order to predetermine the shape of the sealing element. In particular after the material which forms the sealing element has dried or hardened, the sealing element may be pressed into the gas diffusion layer. Alternatively, the material may be pressed in one step and hardened or dried, when the pressing tool can, for example, be heated. Should the material which forms the sealing element be able to be hardened not by means of heat, but instead by means of irradiation, for example, with UV light, the pressing tool may be transparent with respect to such irradiation.

The sealing element may have the following materials or even comprise them: thermoplastic or thermosetting plastics material, for example, polyvinylidene fluoride or chloride, polypropylene, polyethylene, polyolefin, polytetrafluorethylene, or aromatic thermoplastics, such as polyarylether, polyetheretherketone, polysulfone, etc. Examples of thermosetting plastics materials are polyimide, epoxy, polyurethane, nitrile, butyl, thermoplastic elastomers, etc.

In order to be able to press the sealing element into the gas diffusion layer, there can be applied to the sealing element a pressure which may be, for example, between 1 mg/cm² and 20 mg/cm² and in particular between 5 mg/cm² and 10 mg/cm² and, for example, approximately 6 mg/cm². The gas diffusion layer may in the non-compressed state have a thickness which may be between 10 μm and 100 μm and, for example, between 40 μm and 60 μm, and approximately 44 μm.

The pressing tool may be constructed as a tool which can be moved through the pressing device and which comprises a solid material, for example, plastics material or metal. Alternatively, the pressing tool may be constructed as a template which can be placed between a pressing stamp of the pressing device and the sealing element and whose pressing face rests on the sealing element when it is pressed in.

### BRIEF DESCRIPTION OF THE DRAWINGS

The invention is explained below in embodiments with reference to the appended drawings, in which:

FIG. 1 is a schematic plan view of an embodiment of the membrane electrode assembly according to the invention,

FIGS. 2 to 4 are schematic sectioned views of the embodiment of FIG. 1 and with an embodiment of a pressing tool of a production device according to the invention, and

FIG. 5 is a schematic illustration of an embodiment of a production method according to the invention.

### DETAILED DESCRIPTION OF THE INVENTION

The invention is explained below by way of example with reference to embodiments with reference to the drawings. The different features of the embodiments may in this instance be combined independently of each other, as already set out in the individual advantageous embodiments.

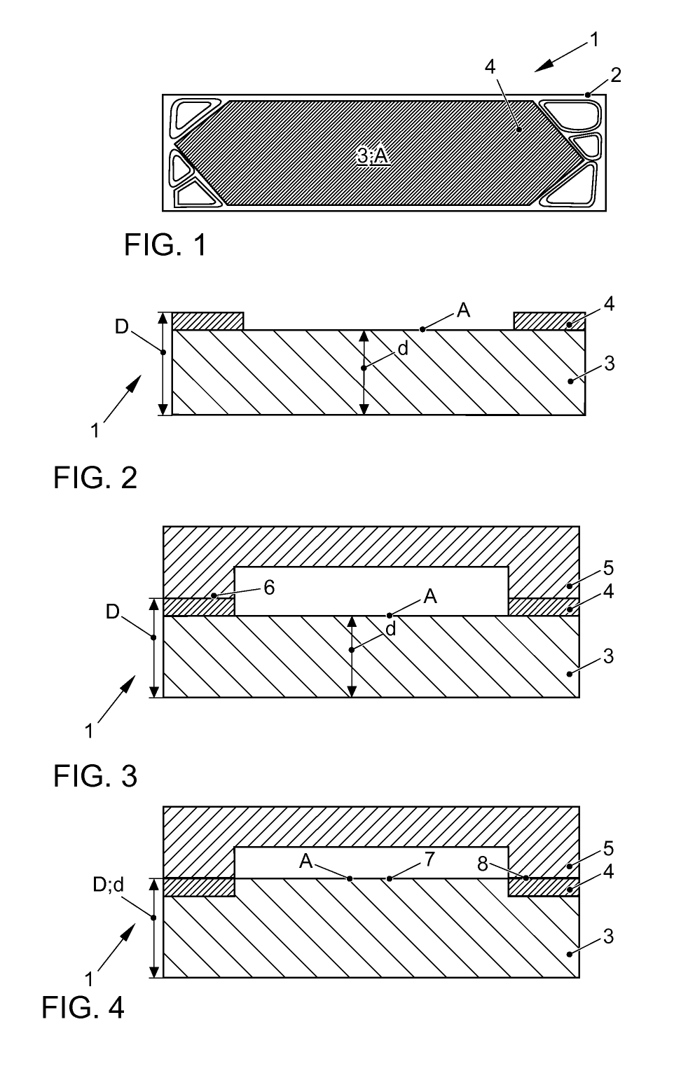

The structure and function of a membrane electrode assembly according to the invention will first be described with reference to the embodiment of FIG. 1.

FIG. 1 is a schematic plan view of the membrane electrode assembly 1 having a membrane carrier 2. A membrane is fitted to the membrane carrier 2. On the membrane there is positioned an electrode, which in the embodiment of FIG. 1 is covered by a gas diffusion layer 3. On the gas diffusion layer 3, there is arranged a sealing element 4 which prevents any potentially gaseous operating medium for a fuel cell from being able to flow laterally out of the gas diffusion layer 3. The sealing element 4 extends around a region A of the gas diffusion layer 3 which is not pressed together or compressed by the sealing element 4. The region A is involved in the reaction of the operating media, wherein the gas diffusion layer 3 allows one of the operating media to pass perpendicularly to the membrane electrode assembly 1.

The membrane electrode assembly 1 is preferably constructed symmetrically with respect to the membrane carrier 2 so that it has two electrodes, between which the membrane is arranged. Furthermore, the membrane electrode assembly 1 may have two gas diffusion layers 3, between which the membrane and the two electrodes are arranged. Furthermore, the membrane electrode assembly 1 may have two sealing elements 4, between which the membrane, the two electrodes and the two gas diffusion layers 3 are arranged. One of the sealing elements 4 may be arranged at the sides of each of the gas diffusion layers 3 facing away from the membrane, wherein at least one of the sealing elements 4 and preferably both of the sealing elements 4 are pressed into the respective gas diffusion layer 3.

FIG. 2 is a schematic sectioned side view of the embodiment of FIG. 1 and as a semi-finished product. The same reference numerals are used for elements which correspond to elements of the embodiment of FIG. 1 in terms of function and/or structure. For the sake of brevity, only the differences with respect to the embodiment of FIG. 1 will be set out below.

In the embodiment of FIG. 2, the sealing element 4 is positioned on the gas diffusion layer 3. The sealing element 4 protrudes from the gas diffusion layer 3 so that an overall thickness D of the gas diffusion layer 3 and the sealing element 4 is greater than a thickness d of the gas diffusion layer 3 alone. The sealing element 4 is, for example, a layer which is pressed onto the gas diffusion layer 3 and which comprises a material which forms the sealing element 4. In the embodiment of FIG. 2, the material which forms the sealing element 4 may already be hardened or not yet hardened.

FIG. 3 shows the embodiment of FIG. 2 with a pressing tool of a production device according to the invention for producing the membrane electrode assembly 1, schematically as a lateral sectioned illustration of FIG. 2. For elements which correspond to elements of the embodiment of FIG. 2 in terms of function and/or structure, the same reference numerals are used. For the sake of brevity, only the differences with respect to the embodiment of FIG. 2 will be set out below.

In the embodiment of FIG. 3, a pressing tool 5 of a pressing device (which is not illustrated for reasons of clarity) of the production device is illustrated. A pressing face 6 of the pressing tool 5 is in abutment with a side of the sealing element 4 facing away from the gas diffusion layer 3. As illustrated in the embodiment of FIG. 3, the shape of the pressing face 6 preferably corresponds to the shape of the sealing element 4 so that the pressing tool 5 during the production of the membrane electrode assembly 1 applies a load only to the sealing element 4. Preferably, the pressing face 6 applies a load over the entire surface of the sealing element 4 so that it can introduce a force which presses the sealing element 4 into the gas diffusion layer 3 over the entire surface into the sealing element 4.

The pressing tool 5 may be provided as a template, whose shape can correspond to the shape of the sealing element 4 and which can be placed between a pressing stamp of the pressing device and the sealing element 4 in order to ensure that the pressing force produced by the pressing stamp is applied only to the sealing element 4 and not directly to the gas diffusion layer 3. As an alternative to providing a template, the pressing tool 5 may be part of the pressing device and, for example, the pressing stamp, wherein the pressing face 6 is arranged on the pressing tool 5 and is formed in accordance with the shape of the sealing element 4.

If the sealing element 4 is applied to and, for example, pressed on the gas diffusion layer 3 by means of a mask, the pressing face 6 is preferably constructed so as to complement the mask.

FIG. 4 shows the embodiment of FIG. 3, wherein the sealing element 4 in the embodiment of FIG. 4 is now pressed into the gas diffusion layer 3 by the pressing tool 5.

In order to ensure that the membrane electrode assembly 1 may have the minimal possible overall thickness D, the sealing element 4 is pressed so far into the gas diffusion layer 3 that the sealing element 4 is in alignment with the gas diffusion layer 3 and, for example, a side 7 of the gas diffusion layer 3 facing away from the membrane is in alignment with a side 8 of the sealing element 4 facing away from the membrane. The overall thickness D of the membrane electrode assembly 1 thus corresponds to the thickness d of the gas diffusion layer 3. In this instance, the sealing element 4 may be in alignment with the gas diffusion layer 3 and, for example, the side 8 of the sealing element 4 facing away from the membrane may be in alignment in particular with the side 7 of the gas diffusion layer 3 facing away from the membrane when the membrane electrode assembly 1 is mounted on a bipolar plate or is assembled with other membrane electrode assemblies 1 for the fuel cell stack. If, when the membrane electrode assembly 1 is produced, the gas diffusion layer 3 is intended to be pressed together not only plastically but also resiliently by the sealing element 4, the sealing element 4 can be pressed into the gas diffusion layer 3 slightly further than illustrated during the production method. If the pressing tool 4 is removed, the gas diffusion layer 3 can resiliently relax until the sealing element 4 and the gas diffusion layer 3 and in particular the sides 7, 8 thereof are aligned with each other.

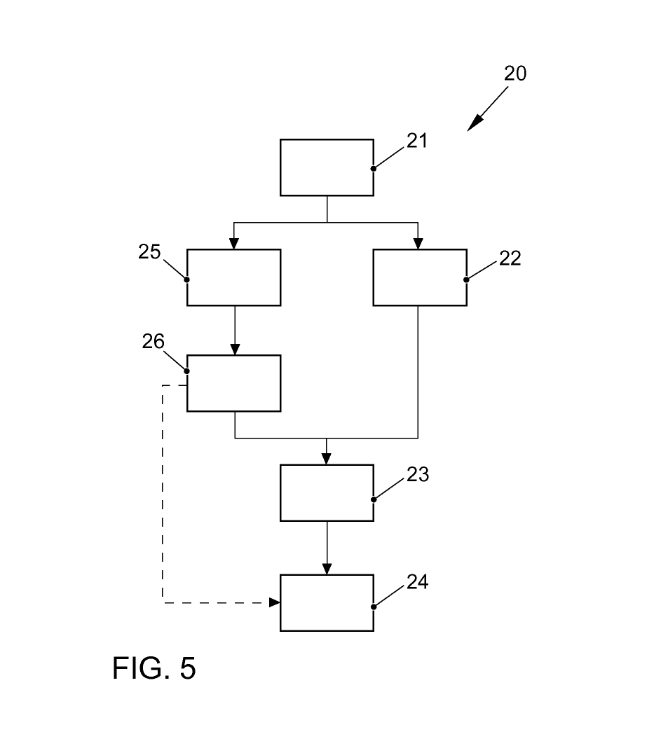

FIG. 5 shows an embodiment of a method according to the invention for producing a membrane electrode assembly 1 for a fuel cell. For elements which are illustrated in FIGS. 1 to 4 and which are used below to explain the method according to the invention, the same reference numerals are used.

In the embodiment of FIG. 5, the method 20 begins with a first method step 21 in which, for example, the gas diffusion layer 3 is applied to an electrode of the membrane electrode assembly 1. The method step 21 may be followed by the method step 22 in which the sealing element 4 is applied to the gas diffusion layer 3. In the method step 23 which now follows, the sealing element 4 is pressed into the gas diffusion layer 3, for example, until the sealing element 4 and the gas diffusion layer 3, or the sides 7, 8 of the gas diffusion layer 3 and the sealing element 4 of the membrane electrode assembly 1 are in alignment with each other, which sides face away from the membrane.

The method step 23 is followed by the method step 24 in which the method 20 ends. For example, the membrane electrode assembly 1 in the method step 24 can be supplied to another method for producing a fuel cell.

Optionally, the method step 21 may be followed by the method step 25 in which a material which forms the sealing element 4 is applied to the gas diffusion layer 3. For example, the material which forms the sealing element 4 may be pressed onto the gas diffusion layer 3. In contrast to applying the completed sealing element 4 in the method step 22, it may be necessary after the method step 25 to harden the material for the sealing element 4 in a method step 26 which follows the method step 24 and thereby to form the sealing element 4. In order to harden the material, it may, for example, be heated or irradiated. For example, the material may be hardened by means of ultraviolet radiation. If the material is intended to be hardened by means of irradiation, the pressing tool 5 may be constructed to direct this radiation to the material for the sealing element 4. In particular a thermally hardenable material for forming the sealing element 4 is advantageous since a pressing tool 5 which is transparent with respect to radiation potentially cannot be readily produced. If the material can be thermally hardened, the pressing tool 5 may be heatable.

The method step 26 may be followed by the method step 23 and then the method step 24. However, the sealing element 4 is preferably hardened in the method step 26 and also in the method step 26 pressed into the gas diffusion layer 3. For example, the material may be heated by the pressing tool 5 and thereby hardened.

### LIST OF REFERENCE NUMERALS

1 Membrane electrode assembly

2 Membrane carrier

3 Gas diffusion layer

4 Sealing element

5 Pressing tool

6 Pressing face

7 Side of the gas diffusion layer facing away from the membrane

8 Side of the sealing element facing away from the membrane

20 Method

21 Start

22 Apply sealing element to the gas diffusion layer

23 Press sealing element into the gas diffusion layer

24 End

25 Apply material for the sealing element to the gas diffusion layer

26 Harden material and form sealing element

A Portion of the gas diffusion layer not pressed together by the sealing element

d Thickness of the gas diffusion layer

D Overall thickness of the membrane electrode assembly

1. A membrane electrode assembly for a fuel cell, comprising:
a membrane,
two electrodes between which the membrane is arranged,
two gas diffusion layers, between which the membrane having the two electrodes is arranged, and
two sealing elements, of which one contacts one of the gas diffusion layers, wherein at least one of the sealing elements is pressed into the gas diffusion layer.

2. The membrane electrode assembly according to claim 1, wherein the sealing element is pressed so far into the gas diffusion layer that the gas diffusion layer and the sealing element are in alignment with each other.

3. The membrane electrode assembly according to claim 1, wherein a portion of the gas diffusion layer, which portion is not pressed together by the sealing element, is not pressed together.

4. A method for producing a membrane electrode assembly for a fuel cell, comprising:
arranging a membrane between two electrodes,
forming one gas diffusion layer at a side of each of the electrodes facing away from the membrane, and
bringing one sealing element into contact with one of the gas diffusion layers (3), such that at least one of the sealing elements is pressed into the gas diffusion layer, with which the sealing element has been brought into contact.

5. The method according to claim 4, wherein the sealing element is pressed so far into the gas diffusion layer that the gas diffusion layer and the sealing element are in alignment with each other.

6. The method according to claim 4, further comprising introducing a pressing force for pressing in the sealing element only into the sealing element.

7. The method according to claim 4, further comprising introducing a pressing force for pressing the sealing element into the sealing element and into a portion of the gas diffusion layer adjacent to the sealing element.

8. A production device for producing a membrane electrode assembly having a gas diffusion layer, comprising a pressing device which is constructed to press a sealing element into the gas diffusion layer.

9. The production device according to claim 8, further comprising a coating device for applying a sealing element, the coating device has a mask which determines the shape of the sealing element, wherein the pressing device has a pressing tool having an active cross-section which is constructed so as to substantially complement the mask.
